(19) United States
(12) Patent Application Publication
(10) Pub. No.: US 2026/0097742 A1
(43) Pub. Date: Apr. 9, 2026

(54) WIPER FRICTION ESTIMATION FOR AUTOWIPER PERFORMANCE IMPROVEMENT

(71) Applicant: Tesla, Inc., Austin, TX (US)

(72) Inventors: Edward Hugh Robert Alley, Mountain View, CA (US); Yun-Ta Tsai, Los Gatos (CA); Tejas Sidarth Maraliga, Austin, TX (US); Muhammed Serkan Simsek, The Hague (NL)

(21) Appl. No.: 18/905,197

(22) Filed: Oct. 3, 2024

(51) Int. Cl. B60S 1/08; B60S 1/04

(52) U.S. Cl. CPC B60S 1/0896; B60S 1/0408

(57) ABSTRACT

Systems and methods for estimating wiper friction in a vehicle can include receiving, by a processor, sensor data indicating electrical power input to a wiper motor and a position of a wiper blade coupled to the wiper motor. Calculating, by the processor, an estimated wiper friction based on an energy balance model using the electrical power input and changes an energy of the wiper blade. Determining, by the processor, an average friction power loss over a defined calculation window of wiper blade movement. The method can also include providing, by the processor, the average friction power loss as an input to an automatic wiper control system.

### BACKGROUND

Modern vehicles can include automatic windscreen (e.g., windshield) wiper systems. The automatic wiper systems can be designed to enhance driver convenience and safety by automatically activating and adjusting wiper speed based on detected moisture or precipitation. These systems typically rely on sensors to detect the presence of water on the windscreen. However, automatic wiper systems often face challenges in accurately differentiating between various environmental conditions such as light rain, heavy rain, snow, ice, or dirt, which can lead to false activations, where wipers operate on a dry windscreen, or insufficient wiping in wet conditions. Such inaccuracies can cause driver frustration and unnecessary wear on wiper blades. Additionally, traditional systems may not account for changes in wiper blade condition over time, affecting wiping performance. Furthermore, these systems generally lack the capability to provide detailed feedback about the actual wiping effectiveness or the condition of the windscreen surface, leading to inefficient wiping patterns and potential safety issues due to inadequate visibility in challenging weather conditions.

### BRIEF DESCRIPTION OF THE SEVERAL VIEWS OF THE DRAWINGS

Various examples are illustrated in the figures of the accompanying drawings. Such examples are demonstrative and not intended to be exhaustive or exclusive examples of the present subject matter.

FIG. 1 illustrates an isometric view of an automotive vehicle, according to some examples.

FIG. 2 illustrates an example schematic diagram of an example of a wiper control system, according to some examples.

FIG. 3 illustrates an example schematic diagram of an example of an energy balance model, according to some examples.

FIG. 4 illustrates an example wiper blade operating within an example of a defined calculation window, according to some examples.

FIG. 5 illustrates an example wiper blade operating outside of an example of a defined calculation window, according to some examples.

FIG. 6 illustrates an example method for estimating wiper, according to some examples.

FIG. 7 illustrates a graphical representation of an example extrapolation of an example position signal, according to some examples.

FIG. 8 illustrates a schematic diagram of an example of using an example extrapolation of an example of a position signal to determine whether an example wiper is operating within or outside of an example of a defined calculation window, according to some examples.

FIG. 9 illustrates a system diagram of an example architecture of an example of an electric vehicle, according to some examples.

FIG. 10 is a block diagram illustrating an example of a machine upon which examples can be implemented, according to some examples.

### DETAILED DESCRIPTION

Automatic windscreen wiper systems can be a standard feature in modern vehicles, potentially enhancing driver convenience and safety by automatically activating and adjusting wiper speed based on detected moisture or precipitation. However, current automatic wiper systems can often rely primarily on infrared or other rain sensors to detect the presence of water on the windscreen, which can lead to suboptimal performance in certain conditions. Existing automatic wiper systems can struggle to accurately differentiate between various environmental conditions affecting the windscreen, such as light rain, heavy rain, snow, ice, or dirt. This can result in false activations, where wipers can operate on a dry windscreen, or insufficient wiping in wet conditions. False detections of debris or water can cause frustrations for the driver of the vehicle as the wipers can be loud while clearing a dry windscreen and can be distracting to a driver. False detections can also be detrimental to windscreen wiper life. Additionally, these systems may not account for changes in wiper blade condition over time, which can affect wiping performance. Furthermore, traditional automatic wiper systems typically lack the ability to provide detailed feedback about the actual wiping effectiveness or the condition of the windscreen surface. This limitation can lead to inefficient wiping patterns, unnecessary wear on wiper blades, and potential safety issues due to inadequate visibility in challenging weather conditions.

The present disclosure can help address these limitations by introducing a novel approach to automatic wiper control that can incorporate real-time wiper friction estimation. By analyzing the energy input to the wiper motor, the resulting wiper movement, and other vehicle states, speed, or environmental (e.g., temperature, wind) conditions, the system can determine the friction between the wiper blade and the windscreen surface. This friction data can provide valuable information about the actual conditions on the windscreen, potentially allowing for more accurate and responsive wiper control.

The example wiper friction estimation systems described in this disclosure can enable several improvements over existing automatic wiper systems. Some examples can provide more accurate detection of wet and dry conditions, potentially reducing false activations and ensuring proper wiping when needed. Some systems can have the ability to differentiate between various types of precipitation or contaminants on the windscreen, potentially allowing for optimized wiping strategies. They can also enable continuous monitoring of wiper blade condition, potentially alerting drivers when replacement can be necessary. Some example systems can offer enhanced integration with other vehicle systems, such as HVAC controls, to address issues like ice formation on the windscreen.

In some examples, a system for estimating wiper friction in a vehicle can include a wiper motor and a wiper blade coupled to the wiper motor. The system can also include an electrical sensor configured to transmit a power signal indicative of an electrical power input to the wiper motor and a position sensor configured to transmit a position signal indicative of a position of the wiper blade relative to a car window. The system can also include a memory and a processor. The memory can include instructions, and the processor can be coupled to the memory and include processing circuitry. The instructions, when performed by the processing circuitry, can cause the processing circuitry to be configured to receive the power signal and the position signal, determine the electrical power input to the wiper motor based on the power signal, determine changes in kinetic and potential energy of the wiper blade based on the position signal, determine an estimated wiper friction using an energy balance model based on the electrical power input and the changes in kinetic and potential energy of the wiper blade, determine an average friction power loss over a defined calculation window of wiper blade movement, and adjust the operation of the wiper blade based on the average friction power loss.

In some examples, a method of estimating wiper friction in a vehicle can include receiving, by a processor, sensor data indicating electrical power input to a wiper motor and a position of a wiper blade coupled to the wiper motor. Calculating, by the processor, an estimated wiper friction based on an energy balance model using the electrical power input and changes in kinetic and potential energy of the wiper blade. Determining, by the processor, an average friction power loss over a defined calculation window of wiper blade movement. The method can also include providing, by the processor, the average friction power loss as an input to an automatic wiper control system.

The above discussion is intended to provide an overview of subject matter of the present patent application. It is not intended to provide an exclusive or exhaustive explanation of the invention. The description below is included to provide further information about the present patent application.

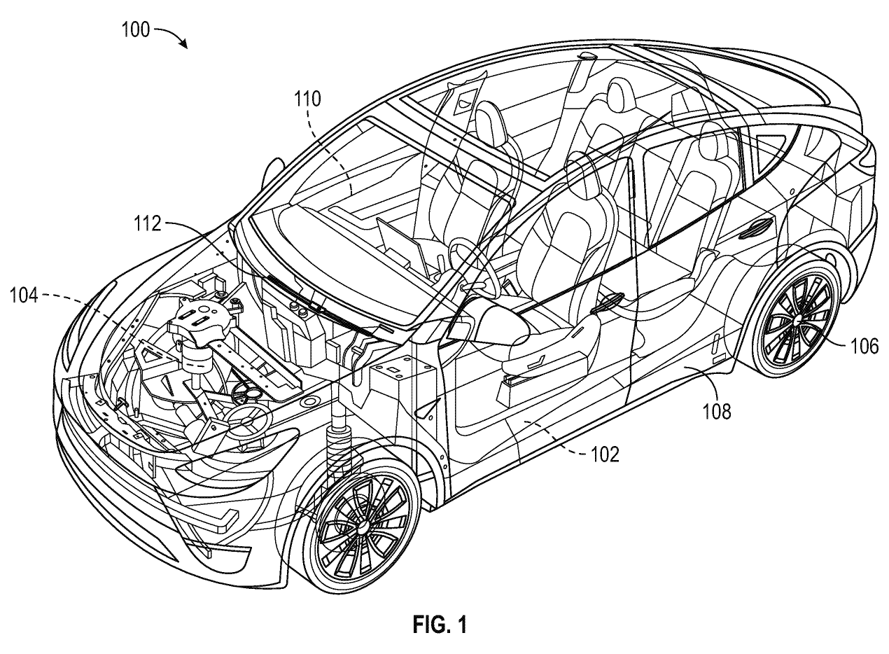

FIG. 1 illustrates an isometric view of an automotive vehicle 100, according to some examples. The automotive vehicle 100 can be a car, vehicle, automobile, or the like, operable to transport occupants or items over a road or other terrain. The automotive vehicle 100 can include a chassis 102, a drivetrain 104, panels 106, and wheels 108. The wheels 108 can engage with a road or terrain and can be configured to support the automotive vehicle 100. The chassis 102 can support the drivetrain 104, which can be connected to the wheels 108. The drivetrain 104 can be operable to drive the wheels 108 to rotate such as to move the automotive vehicle 100. The panels 106 can be connected to the chassis 102 and can help to reinforce the chassis 102 and improve drag or air resistance during transportation. The automotive vehicle 100 can also include one or more seats or seat assemblies securable to the chassis 102 and configured to support, and help restrain, occupants within the automotive vehicle 100.

As discussed in further detail below, the automotive vehicle 100 can also include a windscreen assembly 110 that can be secured or securable to the chassis 102 and can be transparent for occupant forward viewing while in the automotive vehicle 100. The windscreen assembly 110 can include a wiper blade 112, which can include a wiper arm and a blade connected to a wiper motor via a linkage, as discussed in further detail below.

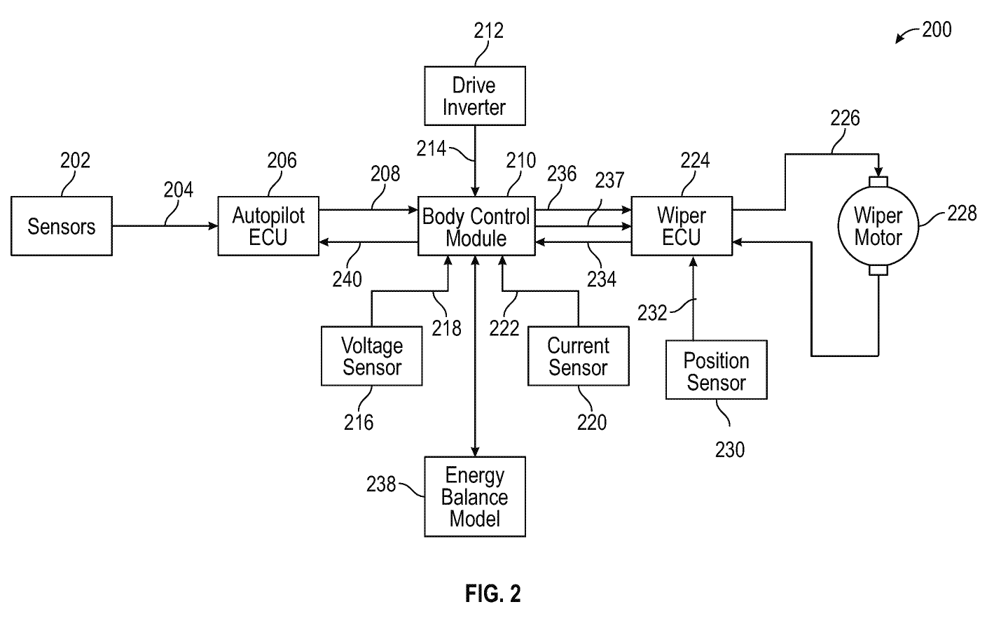

FIG. 2 illustrates an example schematic diagram of an example of a wiper control system 200. The wiper control system 200 can estimate friction between a wiper blade(s) and a windscreen(s) of a vehicle, according to some examples. When debris (e.g., water, rain, ice, frost, or the like) is present, the wiper friction can vary by more than three times (or one third) compared to dry wiping conditions. As shown in FIG. 2, the wiper control system 200 can include one or more sensors 202, an autopilot ECU 206, a body control module 210, a wiper ECU 224, and a wiper motor 228.

The sensors 202 (e.g., image capture devices (e.g., cameras), light detection and ranging (LiDAR), radio detection and ranging (Radar), or the like) can be configured to detect debris, obstacles, or the like, around the vehicle and can be configured to generate and transmit a sensor signal 204 based on the detected debris, obstacles, or the like to the autopilot ECU 206. As discussed herein, the sensors 202 can enable the autopilot ECU 206 to see the environment around the vehicle by transmitting the sensor signal 204.

The autopilot ECU 206 can be configured to operate the vehicle in autopilot (e.g., autonomously or semi-autonomously). The autopilot ECU 206 can include one or more neural networks (e.g., feedforward neural networks (FNNs), convolutional neural networks (CNNs), recurrent neural networks (RNNs), long short-term memory networks (LSTMs), radial basis function networks (RBFNs) modular neural networks (MNNs), Hopfield networks, Boltzmann machines, spiking neural networks (SNNs), or the like) and one or more heuristic algorithms to decide wiper speed. The wiper control system 200 can transmit an estimated wiper friction to the autopilot ECU 206, which can create a feedback loop to the autopilot ECU 206. Essentially, the feedback loop can enable the autopilot ECU 206 to include touch (e.g., the friction between one or more wiper blades and one or more windscreens) and vision (e.g., through sensors installed on the vehicle) to improve the overall performance of the autopilot ECU 206. Thus, the autopilot ECU 206 can receive the sensor signal 204 and alter the operation of the vehicle based on the sensor signal 204 and the estimated frictional force of the wiper blade, among other information. For example, the autopilot ECU 206 can limit a speed, terminate the autopilot navigation, or transmit one or more warnings or alerts to the driver of the vehicle based on the information provided by the sensor signal 204 or an estimated wiper friction 240. The autopilot ECU 206 can also transmit an auto wiper control signal 208 to the wiper motor 228 to control the wipers of the vehicle based on the sensor signal 204.

The body control module 210 can receive the auto wiper control signal 208 and other signals, such as a vehicle speed signal 214 from a drive inverter 212, a wiper voltage signal 218 from a voltage sensor 216, and a wiper current signal 222 from a current sensor 220. The body control module 210 can transmit a wiper speed command 237 to the wiper ECU 224 based on one or more of the auto wiper control signal 208, the vehicle speed signal 214, the wiper voltage signal 218, or the wiper current signal 222. In examples, the voltage sensor 216 and the current sensor 220 can be onboard the body control module 210 and can be configured to determine a voltage (e.g., the wiper voltage signal 218) and current (e.g., the wiper current signal 222) of the electrical power being delivered from the body control module 210 to the wiper ECU 224 and the wiper motor 228 via the wiper ECU power 236. Though voltage and current sensors (e.g., the voltage sensor 216 and the current sensor 220) other sensors can be used to determine the wiper motor power 226, such as sensors to detect an impedance or resistances of the wiper motor 228.

The wiper ECU 224 can receive wiper ECU power 236 and the wiper speed command 237 and the wiper ECU 224 can control the wiper motor power 226 to the wiper motor 228 to control the operation of one or more wiper blades on one or more windscreens of the vehicle. The wiper ECU 224 can receive a wiper position signal 232 based on one or more position sensors 230 attached to or integral to the wiper motor 228. The wiper ECU 224 can transmit a wiper angle feedback 234 to the body control module 210 based on the wiper position signal 232 received from the one or more position sensors 230 in communication with the wiper ECU 224.

The body control module 210 can use any of the inputs to the body control module 210 (e.g., one or more of the auto wiper control signal 208, the vehicle speed signal 214, the wiper voltage signal 218, the wiper current signal 222,the wiper angle feedback 234, ambient temperature (from an onboard temperature sensor), air density (based on a temperature sensor, online weather data, or calculation based on elevation from a GPS or other sensor), or windspeeds (based on online weather data)) in the energy balance model 238 to determine an estimated wiper friction 240. The body control module 210 can transmit the estimated wiper friction 240 to the autopilot ECU 206 to provide information regarding the contact of the one or more wiper blades on the one or more windscreens to the autopilot ECU 206. Thus, the body control module 210 provides the sense of touch to the autopilot ECU 206 to help inform the autopilot ECU 206 in addition to the sense of sight (e.g., via the sensor signals 204) provided by the sensors 202.

Various networked or other ECUs can use the estimated wiper friction 240 to improve one or more systems of the vehicle. For example, the autopilot ECU 206 can use the estimated wiper friction 240 to provide more accurate detection of wet and dry conditions, potentially reducing false activations and ensuring proper wiping when needed. The autopilot ECU 206 can also use the estimated wiper friction 240 to differentiate between various types of precipitation or contaminants on the windscreen, which can permit optimized wiping strategies (e.g., various speeds, patterns, or the like). For example, if the estimated wiper friction 240 is greater than expected, there can be dry wiping conditions. If the estimated wiper friction 240 is less than expected for wet wiping conditions, there can be frost or ice on the windscreen. The body control module 210 or autopilot ECU 206 can also use the estimated wiper friction 240 to enable continuous monitoring of wiper blade condition, potentially alerting drivers when the wiper should be replaced because the wiper is too worn to perform adequately. The body control module 210 can also use the estimated wiper friction 240 to improve integration with other vehicle systems, such as HVAC controls, to address issues like ice formation on the windscreen.

In examples, the body control module 210 can connect to one or more networks (e.g., cellular, wireless, ethernet, or the like), which can provide updates to one or more of the heuristic algorithms or the energy balance model 238 to further tune the accuracy of the estimated wiper friction 240 or the autopilot capabilities of the autopilot ECU 206. Thus, the wiper control system 200 can receive information from one or more offline ECUs (e.g., the wiper angle feedback 234 from the wiper ECU 224) to provide the estimated wiper friction 240 to the autopilot ECU 206 by using the energy balance model 238. The autopilot ECU 206 can use the estimated wiper friction 240 and the sensor signal 204 to transmit an updated version of the auto wiper control signal 208 to the body control module 210 to alter the operations of the wiper blade and the climate control system. For example, the energy balance model 238 can help the body control module 210 ignore false wet detections, confirm wet conditions, or alter the window-clearing approach (e.g., start, stop, speed up, slow down wiping, dispense wiper fluid, turn on climate control, or the like).In some examples, the autopilot ECU 206 can be updated via the one or more networks.

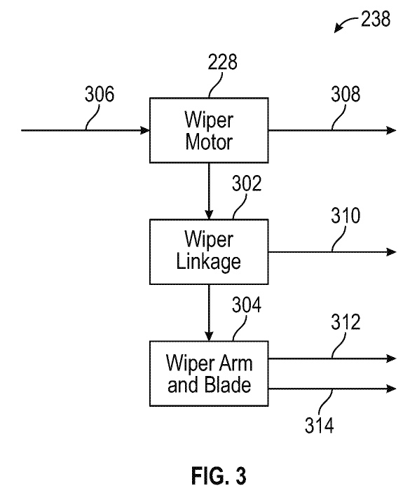

FIG. 3 illustrates an example schematic diagram of an example of an energy balance model 238, according to some examples. The energy balance model 238 can isolate each individual source or sink of energy of the wiper blade system to better understand the frictional losses of the one or more wiper blades on the one or more windscreens. The energy balance model 238 can include accounting for efficiency losses for the wiper motor 228, a wiper linkage 302, and a wiper arm and blade 304. The wiper linkage 302 can include a coupling between the wiper motor 228 and the wiper arm and blade 304. The wiper arm and blade 304 can include an arm, which can connect with the wiper linkage 302 and provide support for a wiper blade. The wiper arm and blade 304 can also include a wiper blade, which can contact the windscreen to provide a blade, edge, or the like, to help remove debris (e.g., rain, water, snow, sleet, frost, or the like) from the windscreen. Thus, the energy balance model 238 can include balancing the inputs to the system and the efficiency losses of the system.

The input to the wiper control system 200 can include an electrical input power 306 (e.g., the wiper motor power 226). The energy balance model 238 can determine the electrical input power 306 via the wiper voltage signal 218 from the voltage sensor 216 and the wiper current signal 222 from the current sensor 220. The electrical input power 306 can be translated to other types of energy by the wiper motor 228; specifically, one or more of the motor efficiency losses 308, or kinetic and potential energy to the wiper linkage 302.

The wiper motor 228 can include one or more motor efficiency losses 308. The motor efficiency losses 308 can include copper losses, iron losses, motor friction losses, windage losses, or the like. The motor efficiency losses 308 can be determined based on the design of the wiper motor 228. Thus, the motor efficiency losses 308 can be fixed, or adjusted based on a relationship of age of the wiper motor 228 relative to time. Thus, an efficiency curve of the wiper motor 228 can be generated by historical testing data of the model of motor and can be used to determine the motor efficiency losses 308. In some examples, the motor efficiency losses 308 can be variable based on the operations of the wiper motor 228. For example, the motor efficiency losses 308 can be updated based on the electrical power input (e.g., the electrical input power 306) and the position of the wiper throughout the wiping cycle. The wiping cycle can determine the motor efficiency losses 308 because the load on the wiper motor 228 can change throughout the wiping cycle.

The wiper linkage 302 can include one or more linkage frictional losses 310. The linkage frictional losses 310 can include losses due to the connections between the wiper motor 228 and the wiper arm and blade 304. Any play, vibration, or unintended movement of the coupling can result in efficiency loss. Additionally, any friction between the components as the wiper blade operates generates heat can result in diminished efficiency of the linkage frictional losses 310.

The wiper arm and blade 304 can include aerodynamic drag losses 312 and blade friction losses 314. The aerodynamic drag losses 312 can include drag losses from the air resistance resulting from air contacting the wiper as the vehicle travels at a speed. The aerodynamic drag losses 312 can increase or decrease the amount of power required to operate the wiper blade and, thus, affect the power consumed by the wiper motor 228. The blade friction losses 314 can include frictional forces between the windscreen and the wiper blade. The conditions (e.g., wet, dry, icy, or the like) can be detected using one or more sensors around the vehicle (e.g., optical sensors, temperature sensors), environmental conditions around the vehicle, or the like. The conditions can alter the coefficient of friction between the wiper blade and the windscreen. Thus, the blade friction losses 314 can alter the power consumed by the wiper motor 228.

The energy balance model 238 can take the electrical input power 306 and balance those inputs against one or more of the outputs (e.g., the motor efficiency losses 308, the linkage frictional losses 310, the aerodynamic drag losses 312, or the blade friction losses 314) to determine a total energy balance and estimate the frictional force of the wiper blade operating on the window (e.g., the difference in the inputs and the one or more outputs can be indicative of the estimated wiper friction 240). As shown in FIG. 2, the body control module 210 can then transmit the output of the energy balance model 238 as the estimated wiper friction 240 to the autopilot ECU 206. As discussed in FIG. 2, the autopilot ECU 206 can use the estimated wiper friction 240 and the sensor signal 204 to compute and transmit an updated version of the auto wiper control signal 208 to the body control module 210 to alter the operations of the wiper blade and the climate control system (e.g., start, stop, speed up, slow down, dispense wiper fluid, turn on climate control, or the like).

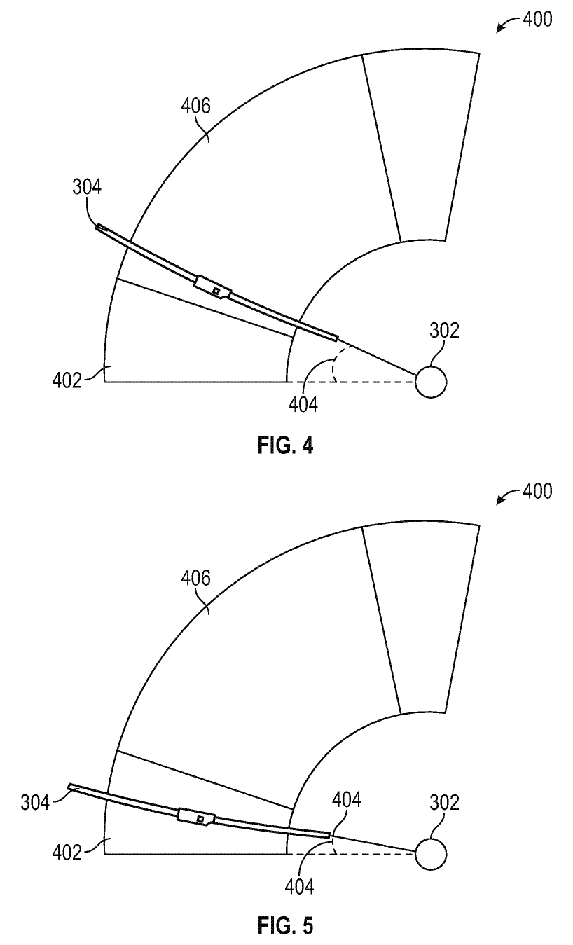

FIG. 4 and FIG. 5 illustrate example wiper blades (e.g., the wiper arm and blade 304) operating along a windscreen 402, according to one or more examples. FIG. 4 illustrates the wiper arm and blade 304 operating within the defined calculation window 406. FIG. 5 illustrates the wiper arm and blade 304 operating outside the defined calculation window 406. As shown in each of FIG. 4 and FIG. 5, an angular position 404 (e.g., the wiper position signal 232 or the wiper angle feedback 234, both in FIG. 2) can change as the wiper arm and blade 304 moves relative to the windscreen 402 such that angular positions 404 can be indicative as to whether the wiper arm and blade 304 are operating within the defined calculation window 406.

The defined calculation window 406 can correspond to a range of wiper blade positions within the operating range of motion of the wiper blade on the windscreen where the wiper blade velocity is highest. This can typically be in the middle of the wiping range, where the blade's movement is more consistent and less affected by acceleration and deceleration at the ends of its travel.

The defined calculation window 406 can be set by determining the portions of the windscreen where acceleration is the lowest but the wiper is moving. Limiting acceleration of the wiper blade in the defined calculation window 406 ensures that the energy balance model 238 runs at the time when the signal-to-noise ratio of blade friction losses 314 is highest, leading to most accurate estimation of blade friction losses 314. For example, outside the defined calculation window 406, the wiper ECU 224 is using much of its power to accelerate the blade, rather than to overcome blade friction losses 314.

The system can be designed to only run the energy model calculations (e.g., with the energy balance model 238) when the wiper angle is within this defined calculation window 406. Limiting the friction estimate calculations to when the wiper is within the defined calculation window 406 can have several benefits. First, limiting the estimated wiper friction calculations to when the wiper is within the defined calculation window 406 can ensure that the power lost to blade friction becomes a significant factor compared to changes in kinetic energy and motor losses, which can be more pronounced during acceleration and deceleration phases (outside the defined calculation window 406). Additionally, the power of blade friction losses 314 can be equal to (Force of friction * velocity), and therefore is highest when the wiper angular velocity is highest. By focusing on the central part of the wipe, where velocity is highest, any inaccuracies in modeled power losses or contributions from other factors can be less significantly affect the estimated wiper friction.

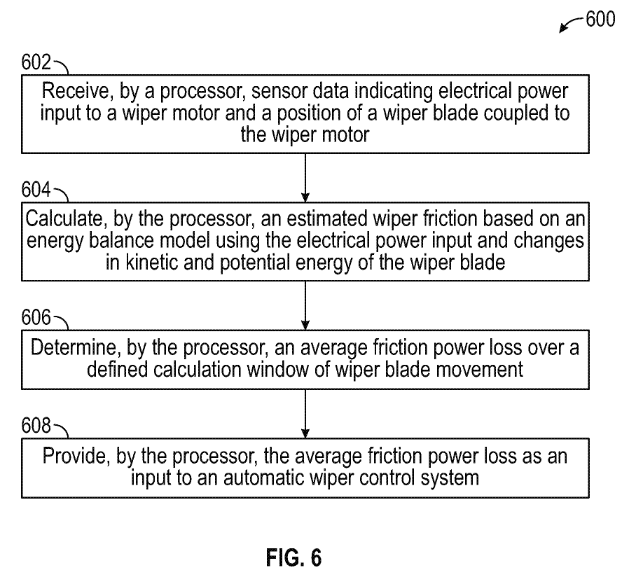

FIG. 6 illustrates an example of a method 600, according to some examples. The method 600 can be used to estimate wiper friction between a wiper blade (e.g., wiper arm and blade 304, FIG. 3) and a windscreen (e.g., the windscreen 402, FIG. 4). As discussed herein, the estimated wiper friction can be used to improve the autopilot wiper control, user enjoyment, and overall autopilot performance. The method 600 can optionally include one or more of operation 602 – operation 608.

At operation 602, the method 600 can optionally include a processor (e.g., the autopilot ECU 206, the body control module 210, the wiper ECU 224, all in FIG. 2, or any other processor in communication with the wiper control system 200, FIG. 2) receiving sensor data indicating electrical power input (e.g., the wiper ECU power 236, FIG. 2, or the electrical input power 306, FIG. 3) to a wiper motor (e.g., the wiper motor 228, FIG. 2) and a position (e.g., the wiper angle feedback 234, FIG. 2 or the angular position 404, FIG. 4) of a wiper blade (e.g., wiper arm and blade 304) coupled to the wiper motor (e.g., wiper motor 228, FIG. 2). The processor can receive current and voltage measurements from current and voltage sensors (e.g., the current sensor 220 and the voltage sensor 216, both in FIG. 2) at a first sampling rate, and can receive wiper motor angular position measurements from a position sensor at a second sampling rate different than the first sampling rate. For example, a lower sampling rate of the angular position can reduce the network bandwidth required or allow lower-cost communication buses (e.g., local interconnect networks (LIN)) in systems upstream of the autopilot ECU 206, such as the wiper angle feedback 234 transmitted from the wiper ECU 224 to the body control module 210, in FIG. 2. The system being able to handle lower sampling rates can help the wiper control system 200 determine the estimated wiper friction 240 utilizing the limited bandwidth LIN systems commonly used in wiper control systems.

At operation 604, method 600 can optionally include the processor calculating an estimated wiper friction (e.g., estimated wiper friction 240, FIG. 2) based on an energy balance model (e.g., the energy balance model 238, FIG. 2 and FIG. 3) using the electrical power input and changes in the kinetic and potential energy of the wiper blade. The processor can extrapolate the wiper blade position and velocity between received angular position measurements to improve the accuracy of the energy balance model calculations, as discussed with regards to FIG. 4.

At operation 606, the method 600 can optionally include the processor determining an average friction power loss over a defined calculation window (e.g., defined calculation window 406, FIG. 4) of wiper blade movement. The defined calculation window can correspond to a range of wiper blade positions where the wiper blade velocity is highest, typically in the middle of the wiping range. The defined calculation window 406 can help ensure that the power lost to blade friction is the highest proportion of losses when compared to changes in kinetic energy and motor losses.

At operation 608, the method 600 can optionally include the processor providing the average friction power loss as an input to an automatic wiper control system (e.g., the autopilot ECU 206, FIG. 2). The processor can compare the average friction power loss to predefined thresholds for wet and dry wiping conditions and can adjust the sensitivity of the automatic wiper control system based on the comparison. In examples, the sensitivity of the automatic wiper control system can be a level of debris, moisture, or the like, that the automatic wiper control system detects before intervening by activating the wiper blade, the climate control, or dispensing windscreen washer fluid.

In some examples, the processor can maintain a long-term average of friction values from times when the wipers are running at a high-probability wet wiping condition and can compare the current average friction power loss to this long-term average to further adjust the sensitivities of the automatic wiper control system. High-probability wet wiping conditions should typically have lower wiper friction estimates than low-probability wet wiping conditions because the liquid on the windscreen can reduce the friction between the wiper blade and the windscreen. The system can also detect debris stuck within the wiping cycle when the estimated wiping friction is higher than it should be for the expected wiper conditions. The higher estimated wiper friction can indicate debris stuck on the windscreen within the wiping range of the wiper blade that is contacting the wiper blade as the wiper blade operates across the windscreen.

The method 600 can also optionally include receiving vehicle speed data (e.g., via the vehicle speed signal 214) and compensating for aerodynamic drag losses in the energy balance model based on the vehicle speed data. Including the vehicle speed data to compensate for aerodynamic drag losses can improve the accuracy of the friction estimation, especially at higher vehicle speeds where aerodynamic effects can be more significant. The method 600 can also optionally include storing a rolling buffer of multiple recent average friction power loss values and updating the estimated wiper friction based on the rolling buffer. Storing the buffer can allow the system to maintain a history of recent friction estimates, potentially improving the accuracy and stability of future wiper friction estimates.

Additionally, the method 600 can include maintaining a long-term average of friction values from times when the wiper blade is running at a high-probability wet wiping condition. The processor can compare a current average friction power loss to this long-term average to adjust the sensitivity of the system. The comparison of the average friction power loss to the long-term average can enable the system to adapt to changing conditions over time and potentially improve the ability of the system to distinguish between wet and dry wiping conditions.

The method 600 can also include determining a change in the friction power loss by comparing successive average friction power loss values. Based on this comparison, if the change in friction power loss is increasing, the processor can decrease the power signal transmitted to the wiper motor. Comparing the successive average friction power losses can allow the system to dynamically adjust wiper operation based on changing friction conditions, potentially optimizing wiper performance and reducing unnecessary wiper movement.

Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

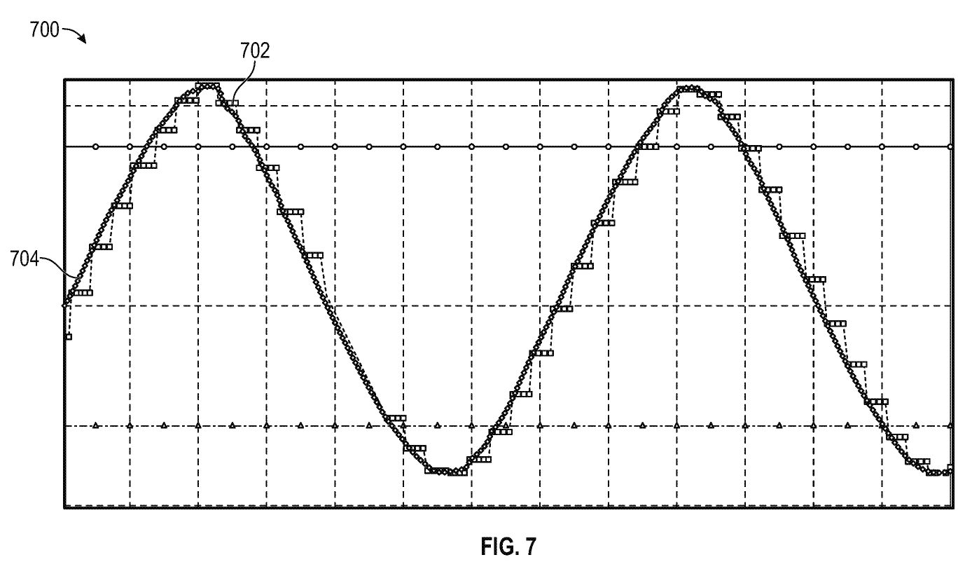

FIG. 7 can illustrate a graphical representation of an example extrapolation of an example low-frequency position signal (e.g., a graph of the wiper position signal 234), according to some examples. As discussed herein, the position sensor (e.g., the position sensor 230, FIG. 2) can include a sampling rate that samples the angular position of the wiper blade (e.g., the wiper arm and blade 304) relative to the windscreen (e.g., the windscreen 402). Thus, to more accurately determine the position of the wiper blade relative to the defined calculation window 406 (FIG. 4) the wiper control system 200 can extrapolate the signal.

The extrapolation process can involve using a lookup table that can store characterized wiper velocities at each wiper angle, based on the current wiping trajectory (e.g., 40 wipes/min, 60 wipes/min). At each time step, the last estimated position can be adjusted by alpha = omega * t, and then that new position can be used to look up the velocity in the subsequent time step. When an updated wiper angle feedback 234 is received, that data, being the most accurate and up-to-date, can be taken as a new source of truth, and the system can update the calculations based on the new truth.

The extrapolation can allow the system to realize the wiper blade enters or exits the defined calculation window earlier than waiting until the next wiper angle feedback 234. The increased sensitivity to determine whether the wiper blade is within the defined calculation window can help control the data used to calculate the estimated wiper friction. More accurately determining whether the wiper is within the defined calculation window can help the system more accurately determine the estimated wiper friction (e.g., the estimated wiper friction 240) by increasing the percentage of the windscreen that is included in the estimated wiper friction while ignoring the portions outside the estimated wiper friction. This approach can ensure that the system captures a more complete and accurate representation of the friction experienced by the wiper blade during its movement across the windscreen.

Extrapolation can also help maintain consistency in the number of time steps included in each average friction power loss calculation. Having significantly different numbers of time steps from wipe to wipe when calculating the average friction power loss value can lead to undesirable wipe-to-wipe variations in the estimated wiper friction. By using extrapolation, the system can ensure a more consistent assessment of entry or exit from the calculation window, potentially leading to more reliable and comparable friction estimates across multiple wipes.

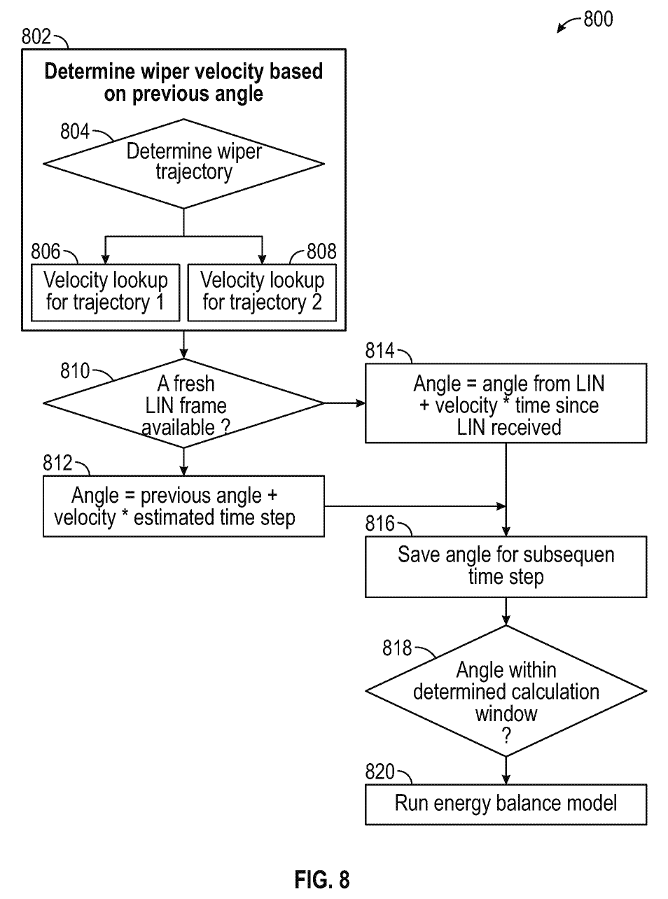

FIG. 8 can illustrate a schematic diagram of an example method 800, according to some examples. The method 800 can be for extrapolation of an example of a position signal (e.g., the wiper angle feedback 234, or the like) to determine whether an example wiper is operating within or outside of an example of a defined calculation window (e.g., the defined calculation window 406).

According to some examples, the method 800 can include determining wiper velocity based on previous angle at operation 802. The method can then include determining wiper trajectory at sub-operation 804. Based on the determined trajectory, the method can proceed to either velocity lookup for trajectory 1 at sub-operation 806 or velocity lookup for trajectory 2 at sub-operation 808.

The method 800 can then include checking if a fresh LIN frame is available at decision block 810. If a fresh LIN frame is available, the method can proceed to operation 814, where the angle can be calculated as the angle from LIN + velocity * time since LIN received. If a fresh LIN frame is not available, the method can proceed to operation 812, where the angle can be calculated as the previous angle + velocity * estimator time step.

The method 800 can also optionally include saving the angle for subsequent time step at operation 816. The method can then proceed to decision block 818 to determine if the angle is within the determined calculation window.

If the angle indicates the wiper blade is within the determined calculation window, the method 800 can include running the energy balance model (e.g., the energy balance model 238, FIG. 2) at operation 820. This energy balance model can be used to estimate wiper friction based on the electrical power input and changes in kinetic and potential energy of the wiper blade and other efficiency losses as discussed in FIG. 4.

This method 800 can allow for a more accurate and timely estimation of wiper friction by extrapolating between LIN frames and focusing calculations within the defined calculation window. The use of velocity lookup tables based on different trajectories can account for various wiping speeds and patterns, potentially improving the accuracy of the friction estimation across different operating conditions. Thus, the method 800 can lead to more efficient wiper systems and improved safety in vehicles.

Although the example method 800 depicts a particular sequence of operations, the sequence can be altered without departing from the scope of the present disclosure. For example, some of the operations depicted can be performed in parallel or in a different sequence that does not materially affect the function of the method 800. In other examples, different components of an example device or system that implements the method 800 can perform functions at substantially the same time or in a specific sequence. Moreover, the method 800 can comprise additional operations and sub-operations, as shown in the figure, including the initial operation 802 for determining wiper velocity based on the previous angle.

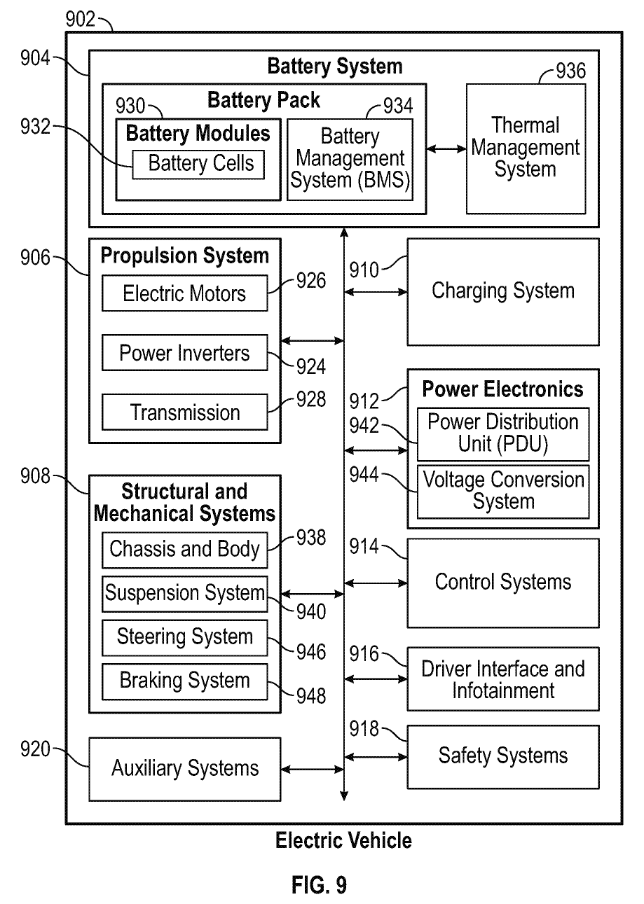

FIG. 9 illustrates a system diagram of an example architecture of an example of an electric vehicle 902. This diagram can show systems and sub-systems that collectively can enable the functionality and operational efficiency of an electric vehicle 902.

The electric vehicle 902 can include a number of higher-level systems that can be interconnected, including a battery system 904, a propulsion system 906, structural and mechanical systems 908, a charging system 910, power electronics 912, control systems 914, driver interface and infotainment 916, safety systems 918, and auxiliary systems 920.

The propulsion system 922 can include one or more electric motors 926, which can include traction motors for propulsion and motors for regenerative braking systems. The one or more electric motors 926 can convert electrical energy into mechanical energy. Power inverters 924 can facilitate the conversion of DC power from the battery to AC power required by the electric motors 926. The propulsion system can also include a transmission 928, which can consist of a single-speed transmission or gearbox, channeling mechanical power to the vehicle's wheels.

The battery system 904 can be composed of several battery modules 930, each housing multiple battery cells 932. These battery cells 932 can be based on various chemistries, including lithium-ion, lithium-polymer, or solid-state materials, each offering distinct advantages in terms of energy density, recharge cycles, and safety profiles.

A battery management system (BMS) 934 can continuously monitor various parameters, such as voltage, current, and temperature of each of the battery cells 932 and battery modules 930, to prevent conditions that could lead to overcharging, deep discharging, or thermal runaway. The battery management system (BMS) 934 can also manage the state of charge (SoC) and state of health (SoH) of the battery, ensuring that the energy can be distributed during discharge and that the charging process can be optimized for longevity and safety. Each battery management system (BMS) 934 can employ algorithms to balance the charge across the cells and modules, correcting imbalances that can reduce the battery's overall capacity and lifespan.

Integrated with the battery system 904 can be a thermal management system 936, which can operatively maintain the battery cells 932 within specified temperature ranges. The thermal management system 936 can employ temperature sensors to monitor the heat generated by the battery cells 932 during operation. Based on the data collected, it can activate cooling and heating mechanisms to regulate the battery's temperature. Cooling methods can include air cooling, where ambient air can be circulated around the battery modules, or liquid cooling, where a coolant can be circulated through channels in or around the battery modules to absorb and dissipate heat. In colder environments, the thermal management system 936 can employ heating elements or use waste heat from the vehicle's systems to warm the battery cells, ensuring they can operate efficiently even in low temperatures.

The charging system 910 can operatively replenish the stored energy within the battery system 904 of the electric electric vehicle 902. It can support various charging methodologies to ensure flexibility and convenience in energy restoration. The charging system 910 can encompass systems for both standard (Level 1 and Level 2) and fast charging (DC fast charging), facilitating a range of charging speeds to suit different user needs and infrastructure capabilities.

For standard charging, the charging system 910 can include an onboard charger for AC/DC conversion. This onboard charger can convert the alternating current (AC) from the electrical grid or home outlets into direct current (DC) that can be stored in the vehicle's battery system 904. The onboard charger can, for example, support Level 1 and Level 2 charging, with Level 1 charging using standard household outlets (908-120V) and Level 2 charging requiring a higher voltage source (308-240V), such as those found in dedicated charging stations or installed in residential garages.

For fast charging, the charging system 910 can incorporate a DC fast charging system, designed for rapid energy transfer directly to the vehicle's battery system 904, bypassing the onboard charger. DC fast charging stations can supply high-voltage (e.g., 400V to 800V) direct current directly to the battery system 904.

Additionally, the electric vehicle 902 can be equipped with an auxiliary battery, such as a 12V lead-acid or lithium-ion battery that can be tasked with powering the vehicle's low-voltage systems, including lighting, infotainment, electronic control units, and other ancillary components, ensuring their operation even when the main battery system can be off or during the initial stages of charging when the main system's voltage might be too low for these tasks. This separation of power sources can enhance the vehicle's electrical system reliability and can ensure the availability of essential functions.

Structural and mechanical systems 908, including a chassis and body 938 and suspension system 940, can provide the physical framework and support for the electric vehicle 902. The chassis and body 938 can constitute the vehicle's primary structure, while the suspension system 940, which can include springs, shock absorbers (or dampers), and control arms, can provide a smooth and stable ride by mitigating road shocks and vibrations.

Power electronics 912, including a power distribution unit (PDU) 942 and a voltage conversion system 944, can be responsible for the management and conversion of electrical power within the vehicle. The power distribution unit (PDU) 942, equipped with fuses and relays, can distribute power to various vehicle systems, while voltage conversion devices of the voltage conversion system 944, such as DC/DC and AC/DC converters, can adjust the voltage levels to meet the specific requirements of different components.

Control systems 914 can facilitate the driver's command over the vehicle, with a steering system 946 and a braking system 948 as examples. The steering system 946, including a power steering motor, can allow for precise directional control, whereas the braking system 948, which can feature disc brakes and an anti-lock braking system (ABS), can enable deceleration and stopping.

The driver interface and infotainment 916 can support the driving experience by providing vehicle information and entertainment options through digital displays and multimedia systems. Connectivity features, such as Bluetooth and USB, can further augment functionality.

Safety systems 918, designed to protect the vehicle's occupants, can include airbag systems and advanced driver-assistance systems (ADAS), for example. ADAS can use an array of sensors, cameras, radar, LiDAR, and/or ultrasonic devices to monitor the vehicle's surroundings, detect potential hazards, and execute or suggest corrective actions to prevent accidents and mitigate their impact.

ADAS can be categorized into different levels of self-driving capabilities, ranging from Level 0, where the human driver can perform all driving tasks, to Level 5, which can represent full automation with no human intervention required under any circumstances. Levels 1 and 2 can focus on driver assistance and partial automation, respectively, where systems such as adaptive cruise control, lane-keeping assistance, and automatic emergency braking can support the driver but do not replace them. Level 3, conditional automation, can allow the vehicle to handle all aspects of driving in certain conditions, but can require the driver to be ready to take control when needed. Level 4, high automation, can enable the vehicle to operate independently in most scenarios, though human override can still be possible.

Examples of ADAS that can contribute to these levels of automation can include, but are not limited to, adaptive cruise control, which can adjust the vehicle's speed to maintain a safe distance from vehicles ahead; lane departure warning systems, which can alert the driver when the vehicle begins to drift out of its lane; and automatic parking systems, which can assist or take over control of the vehicle during parking maneuvers. More advanced systems, contributing to higher levels of automation, can involve complex algorithms and machine learning capabilities to interpret sensor data, predict actions of other road users, and make real-time driving decisions.

Auxiliary systems 920 can support the vehicle's functions and occupant comfort, with climate control and lighting systems as examples. The auxiliary systems 920 can also include windscreen wipers etc.

As noted above, the systems of the electric vehicle 902 can be communicatively connected. Communications between the interconnected systems within electric vehicle 902 can be facilitated through a vehicle network architecture, employing both hardware and software components to ensure seamless data exchange and coordination. This network architecture can include one or more vehicle communication buses, such as for example Controller Area Network (CAN), Local Interconnect Network (LIN), FlexRay, and Ethernet, which can serve as the backbone for intra-vehicle communications.

The Controller Area Network (CAN) bus can be a vehicle bus standard designed to allow microcontrollers and devices to communicate with each other within the electric vehicle 902 without a host computer. Such a network can support control communications between systems such as the battery system 904, propulsion system 906, and control systems 914, due to its high reliability and resistance to interference. A CAN bus can support messages that ensure real-time control and monitoring of these systems.

For other communications, such as those involving the driver interface and infotainment 916 or auxiliary systems 920, a Local Interconnect Network (LIN) bus can be employed. LIN can provide a cost-effective, low-speed serial communication system for connecting intelligent sensors and actuaries. It can serve as a sub-network to the CAN bus, handling signals such as switch inputs and actuator outputs.

FlexRay technology can offer a higher data rate compared to CAN and LIN, providing the necessary bandwidth for advanced control systems, including those required for autonomous driving functionalities within safety systems 918. Its deterministic nature and fault tolerance can make it suitable for applications that require precise timing and synchronization, such as coordinating the actions of multiple control units in real-time.

Ethernet, with its high data transfer rate, can for example be adopted for diagnostics and infotainment applications within the electric vehicle 902. It can support the rapid transfer of large volumes of data, making it well suited for advanced driver assistance systems (ADAS), software updates, and multimedia streaming in the driver interface and infotainment 916 system.

Software protocols and application programming interfaces (APIs) built on top of these physical layers can enable high-level communication and data exchange between systems. These protocols can define the rules for data format, timing, and error handling, ensuring that messages can be correctly interpreted and acted upon by the receiving systems.

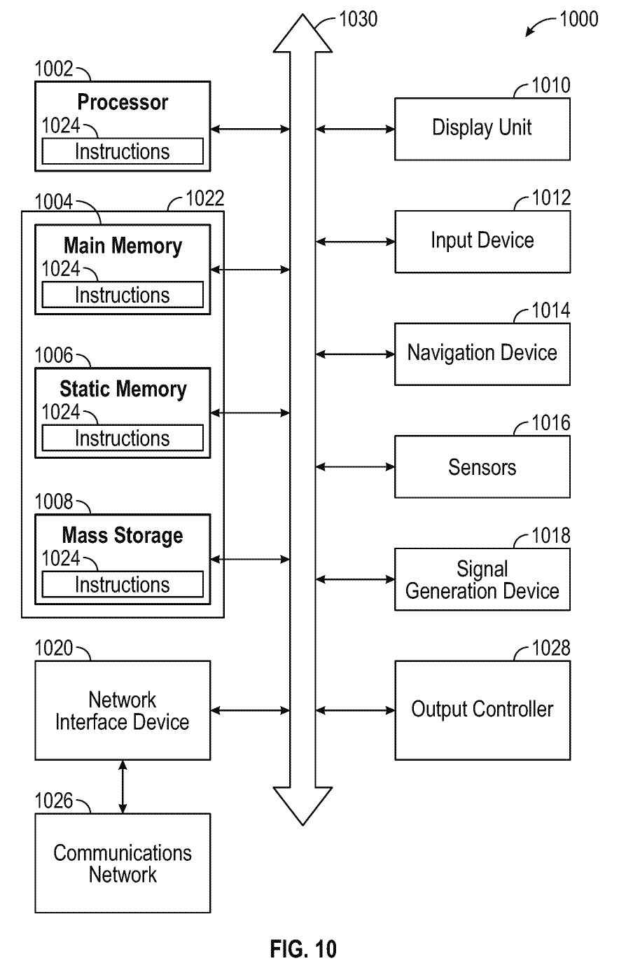

FIG. 10 illustrates a block diagram of an example machine 1000 upon which any techniques (e.g., methodologies) discussed herein can perform. As described herein, examples can include, or can operate by, logic or a number of components or mechanisms in the machine 1000. Circuitry (e.g., processing circuitry) is a collection of circuits implemented in tangible entities of machine 1000, including hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other circuitry components when the device is operating. In an example, any of the physical components can be used in more than one member of more than one circuitry. For example, under operation, execution units can be used in a first circuit of a first circuitry at one point in time and reused by a second circuit in the first circuitry or by a third circuit in a second circuitry at a different time. Additional examples of these components with respect to the machine 1000 follow.

In alternative examples, the machine 1000 can operate as a standalone device or be connected (e.g., networked) to other machines. In a networked deployment, the machine 1000 can operate in the capacity of a server machine, a client machine, or both in server-client network environments. In an example, the machine 1000 can act as a peer machine in peer-to-peer (P2P) (or other distributed) network environment. The machine 1000 can be a personal computer (PC), a tablet PC, a set-top box (STB), a personal digital assistant (PDA), a mobile telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1000 can include a hardware processor 1002 (e.g., a central processing unit (CPU), a graphics processing unit (GPU), a hardware processor core, or any combination thereof), a main memory 1004, a static memory (e.g., memory or storage for firmware, microcode, a basic-input-output (BIOS), and mass storage 1008 (e.g., hard drives, tape drives, flash storage, or other block devices) some or all of which can communicate with each other via an interlink 1030 (e.g., bus). The machine 1000 can further include a display unit 1010, an alphanumeric input device 1012 (e.g., a keyboard), and a user interface (UI) navigation device 1014 (e.g., a mouse). In examples, the display unit 1010, input device 1012 and UI navigation device 1014 can be a touch screen display. The machine 1000 can include a signal generation device 1018 (e.g., a speaker), a network interface device 1020, and one or more sensors 1016, such as a global positioning system (GPS) sensor, compass, accelerometer, or other sensor. The machine 1000 can include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1002, the main memory 1004, the static memory 1006, or the mass storage 1008 can be, or include, a machine-readable medium 1022 on which is stored one or more sets of data structures or instructions 1024 (e.g., software) embodying or utilized by any one or more of the techniques or functions described herein. The instructions 1024 can also reside, completely or at least partially, within any of the registers of the processor 1002, the main memory 1004, the static memory 1006, or the mass storage 1008 during execution by the machine 1000. Any combination of the hardware processor 1002, the main memory 1004, the static memory 1006, or the mass storage 1008 can constitute the machine-readable media 1022. While the machine-readable medium 1022 is illustrated as a single medium, “machine-readable medium” can include a single medium or multiple media (e.g., a centralized or distributed database or associated caches and servers) configured to store one or more instructions 1024.

The term “machine-readable medium” can include any medium that is capable of storing, encoding, or carrying instructions for execution by the machine 1000 and that causes the machine 1000 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). A non-transitory machine-readable medium comprises a machine-readable medium with a plurality of particles having invariant (e.g., rest) mass and, thus, are compositions of matter. Accordingly, non-transitory machine-readable media are machine-readable media that do not include transitory propagating signals. Specific examples of non-transitory machine-readable media can include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

Information stored or otherwise provided on the machine-readable medium 1022 can represent instructions 1024, such as instructions 1024 themselves or a format from which the instructions 1024 can be derived. This format from which the instructions 1024 can be derived can include source code, encoded instructions (e.g., in compressed or encrypted form), packaged instructions (e.g., split into multiple packages), or the like. The information representative of the instructions 1024 in the machine-readable medium 1022 can be processed by processing circuitry into the instructions to implement any of the operations discussed herein. For example, deriving the instructions 1024 from the information (e.g., processing by the processing circuitry) can include compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1024.

In an example, the derivation of the instructions 1024 can include assembly, compilation, or interpretation of the information (e.g., by the processing circuitry) to create the instructions 1024 from some intermediate or preprocessed format provided by the machine-readable medium 1022. When provided in multiple parts, the information can be combined, unpacked, and modified to create the instructions 1024. For example, the information can be in multiple compressed source code packages (object code, binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable, etc.) at a local machine, and executed by the local machine.

The instructions 1024 can be further transmitted or received over a communications network 1026 using a transmission medium via the network interface device 1020 utilizing any one of several transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 902.11 family of standards known as Wi-Fi®, IEEE 902.15.4 family of standards, peer-to-peer (P2P) networks, among others. The network interface device 1020 can include one or more physical jacks (e.g., Ethernet, coaxial, or phone jacks) or one or more antennas to connect to the communications network 1026. The network interface device 1020 can include a plurality of antennas to wirelessly communicate using at least one of single-input multiple-output (SIMO), multiple-input multiple-output (MIMO), or multiple-input single-output (MISO) techniques. The term “transmission medium” shall include any intangible medium capable of storing, encoding or carrying instructions for execution by the machine 1000, and includes digital or analog communications signals or other intangible medium to facilitate communication of such software. A transmission medium is a machine-readable medium.

The following non-limiting examples detail certain aspects of the present subject matter to solve the challenges and provide the benefits discussed herein, among others.

Example 1 is a system for estimating wiper friction in a vehicle, comprising: a wiper motor; a wiper blade coupled to the wiper motor; an electrical sensor configured to transmit a power signal indicative of an electrical power input to the wiper motor; a position sensor configured to transmit a position signal indicative of a position of the wiper blade relative to a car window; a memory including instructions; and a processor coupled to the memory and including processing circuitry, the instructions, when performed by the processing circuitry are configured to cause the processing circuitry to: receive the power signal and the position signal; determine, based on the power signal, the electrical power input to the wiper motor; determine, based on the position signal, changes in kinetic and potential energy of the wiper blade; determine, using an energy balance model based on the electrical power input and the changes in kinetic and potential energy of the wiper blade, an estimated wiper friction; determine an average friction power loss over a defined calculation window of wiper blade movement; and adjust, based on the average friction power loss, operation of the wiper blade.

In Example 2, the subject matter of Example 1 optionally includes wherein the processor is further configured to: receive vehicle speed data; and compensate for aerodynamic drag losses of the wiper blade in the energy balance model based on the vehicle speed data.

In Example 3, the subject matter of any one or more of Examples 1–2 optionally include wherein the defined calculation window corresponds to a range of wiper blade positions where an acceleration of the wiper blade is below a threshold.

In Example 4, the subject matter of Example 3 optionally includes wherein the defined calculation window includes a middle portion of an operating range of the wiper blade.

In Example 5, the subject matter of Example 4 optionally includes wherein the middle portion includes around two-thirds of the operating range of the wiper blade.

In Example 6, the subject matter of any one or more of Examples 1–5 optionally include wherein the processor is further configured to: generate, by comparing the average friction power loss to set thresholds for wet and dry wiping conditions, a wiper condition comparison; and adjust a sensitivity of the automatic wiper control system based on the wiper condition comparison.

In Example 7, the subject matter of any one or more of Examples 1–6 optionally include wherein the electrical sensor comprises: a current sensor configured to transmit a measured current input indicative of current input to the wiper motor; and a voltage sensor configured to transmit a measured voltage input indicative of voltages input to the wiper motor.

In Example 8, the subject matter of Example 7 optionally includes wherein to determine, based on the power signal, the electrical power input to the wiper motor, the instructions cause the processing circuitry to: receive the measured current input; receive the measured voltage input; and determine, based on the measured current input and the measured voltage input, the electrical power input to the wiper motor.

In Example 9, the subject matter of any one or more of Examples 1–8 optionally include wherein the position sensor is configured to transmit a measured angular position indicative of an angular position of the wiper motor.

In Example 10, the subject matter of Example 9 optionally includes wherein to determine, based on the position signal, changes in kinetic and potential energy of the wiper blade, the instructions cause the processing circuitry to: receive the measured angular position; and determining, based on the measured angular position, changes in kinetic and potential energy of the wiper blade.

In Example 11, the subject matter of any one or more of Examples 9–10 optionally include wherein the processor is further configured to: receive, from the position sensor, wiper motor angular position measurements at a first sampling rate; receive, from the electrical sensor, electrical power input measurements at a second sampling rate, the second sampling rate different than the first sampling rate; and extrapolate wiper blade position and velocity between received angular position measurements.

In Example 12, the subject matter of any one or more of Examples 1–11 optionally include wherein the processor is further configured to: store a rolling buffer of multiple recent average friction power loss values; and use the rolling buffer to reduce changes of automatic wiper control system based on a single inaccurate friction estimate.

In Example 13, the subject matter of any one or more of Examples 1–12 optionally include wherein the processor is further configured to: maintain a long-term average of friction values from times when the wiper blade is running at a high-probability wet wiping condition; and compare a current average friction power loss to the long-term average to adjust a sensitivity of the automatic wiper control system.

In Example 14, the subject matter of any one or more of Examples 1–13 optionally include wherein the processor is further configured to: determine a slope of successive average friction power loss estimates; and decrease a commanded wiping speed of the automatic wiper control system when the slope indicates increasing friction estimates.

In Example 15, the subject matter of Example 14 optionally includes a body control module including the processor; and a wiper controller in communication with the body control module and configured to control the wiper motor and to transmit the position signal and the power signal to the body control module.

In Example 16, the subject matter of Example 15 optionally includes wherein the body control module is configured to receive over-the-air updates to update the energy balance model.

In Example 17, the subject matter of any one or more of Examples 15–16 optionally include an autopilot controller configured to autonomously drive the vehicle, wherein the body control module is configured to transmit the average friction power loss to the autopilot controller to reinforce detected wet conditions or suppress false wet conditions detected.

Example 18 is a method comprising: receiving, by a processor, sensor data indicating electrical power input to a wiper motor and a position of a wiper blade coupled to the wiper motor; calculating, by the processor, an estimated wiper friction based on an energy balance model using the electrical power input and changes in kinetic and potential energy of the wiper blade; determining, by the processor, an average friction power loss over a defined calculation window of wiper blade movement; and providing, by the processor, the average friction power loss as an input to an automatic wiper control system.

In Example 19, the subject matter of Example 18 optionally includes receiving, by the processor, vehicle speed data; and compensating, by the processor, for aerodynamic drag losses in the energy balance model based on the vehicle speed data.

In Example 20, the subject matter of any one or more of Examples 18–19 optionally include receiving, by the processor, wiper motor angular position measurements at a first sampling rate; receiving, by the processor, electrical power input measurements at a second sampling rate different than the first sampling rate; extrapolating, by the processor, wiper blade position and velocity between received angular position measurements; comparing, by the processor, the average friction power loss to predefined thresholds for wet and dry wiping conditions; and adjusting, by the processor, a sensitivity of the automatic wiper control system based on the comparison.

Example 21 includes a method, system, apparatus, or device including any element of any of examples 1–20.

The above-detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A system for estimating wiper friction in a vehicle, the system comprising:
a wiper motor configured to move a wiper blade across a windscreen;
an electrical sensor configured to transmit a power signal indicative of electrical power used by the wiper motor to move the wiper blade;
a position sensor configured to transmit a position signal indicative of a position of the wiper blade relative to the windscreen;
a processor configured to:
receive the power signal and the position signal;
determine, based on the power signal, the electrical power used by the wiper motor;
determine, based on the position signal, a change in an energy of the wiper blade;
determine, using an energy balance model based on the electrical power and the change in the energy of the wiper blade, an estimated wiper friction;
determine, based at least in part on the estimated wiper friction, an average friction power loss over a defined calculation window of wiper blade movement; and
adjust, based on the average friction power loss, operation of the wiper blade.

2. The system of claim 1, wherein the processor is further configured to:
receive vehicle speed data;
compensate for aerodynamic drag losses of the wiper blade in the energy balance model based at least in part on the vehicle speed data; and
update, based on the aerodynamic drag losses, the estimated wiper friction.

3. The system of claim 1, wherein the defined calculation window corresponds to a range of wiper blade positions where an acceleration of the wiper blade is below a threshold.

4. The system of claim 3, wherein the defined calculation window includes a middle portion of an operating range of motion of the wiper blade.

5. The system of claim 4, wherein the middle portion includes around two-thirds of the operating range of motion of the wiper blade.

6. The system of claim 1, wherein the processor is further configured to:
generate, by comparing the average friction power loss to set thresholds for wet and dry wiping conditions, a wiper condition comparison; and
adjust a sensitivity of the system based on the wiper condition comparison.

7. The system of claim 1, wherein the electrical sensor comprises:
a current sensor configured to transmit a measured current indicative of electrical current used by the wiper motor; and
a voltage sensor configured to transmit a measured voltage indicative of electrical voltage of power used by the wiper motor.

8. The system of claim 7, wherein to determine, based on the power signal, the electrical power used by the wiper motor, the processor is configured to:
receive the measured current;
receive the measured voltage; and
determine, based on the measured current and the measured voltage, the electrical power used by the wiper motor.

9. The system of claim 1, wherein the position sensor is configured to transmit a measured angular position indicative of an angular position of the wiper motor.

10. The system of claim 9, wherein to determine, based on the position signal, changes in the energy of the wiper blade, the processor is configured to:
receive the measured angular position; and
determining, based on the measured angular position, changes in kinetic and potential energy of the wiper blade.

11. The system of claim 9, wherein the processor is further configured to:
receive, from the position sensor, wiper motor angular position measurements at a first sampling rate;
receive, from the electrical sensor, electrical power input measurements at a second sampling rate, the second sampling rate different than the first sampling rate; and
extrapolate wiper blade position and velocity between received angular position measurements.

12. The system of claim 1, wherein the processor is further configured to:
store a rolling buffer of multiple recent average friction power loss values; and
updating, based on the rolling buffer, the estimated wiper friction.

13. The system of claim 1, wherein the processor is further configured to:
maintain a long-term average of friction values from times when the wiper blade is running at a high-probability wet wiping condition; and
compare a current average friction power loss to the long-term average to adjust a sensitivity of the system.

14. The system of claim 1, wherein the processor is further configured to:
determine, by comparing successive average friction power loss values, a change in the friction power loss; and
decrease, based on the change in the friction power loss increasing, the power signal transmitted to the wiper motor.

15. The system of claim 14, comprising:
a body control module including the processor; and
a wiper controller in communication with the body control module, the wiper controller configured to control the wiper motor and to transmit the position signal and the power signal to the body control module.

16. The system of claim 15, wherein the body control module is configured to receive over-the-air updates to update the energy balance model.

17. The system of claim 15, comprising:
an autopilot controller configured to autonomously drive the vehicle, wherein the body control module is configured to transmit the average friction power loss to the autopilot controller to reinforce detected wet conditions or suppress false wet conditions detected.

18. A method comprising:
receiving, by a processor, sensor data indicating electrical power input to a wiper motor and a position of a wiper blade coupled to the wiper motor;
calculating, by the processor, an estimated wiper friction based on an energy balance model using the electrical power input and changes in kinetic and potential energy of the wiper blade;
determining, by the processor, an average friction power loss over a defined calculation window of wiper blade movement; and
providing, by the processor, the average friction power loss as an input to an automatic wiper control system.

19. The method of claim 18, further comprising:
receiving, by the processor, vehicle speed data; and
compensating, by the processor, for aerodynamic drag losses in the energy balance model based on the vehicle speed data.

20. The method of claim 18, further comprising:
receiving, by the processor, wiper motor angular position measurements at a first sampling rate;
receiving, by the processor, electrical power input measurements at a second sampling rate different than the first sampling rate;
extrapolating, by the processor, wiper blade position and velocity between received angular position measurements;
comparing, by the processor, the average friction power loss to predefined thresholds for wet and dry wiping conditions; and
adjusting, by the processor, a sensitivity of the automatic wiper control system based on the comparison.
